(19) United States
(12) Patent Application Publication
(10) Pub. No.: US 2020/0236731 A1
(43) Pub. Date: Jul. 23, 2020

(54) CALL PRIORITIZING METHOD PERFORMED BY TERMINAL IN WIRELESS COMMUNICATION SYSTEM, AND TERMINAL USING METHOD

(71) Applicant: LG ELECTRONICS INC., Seoul (KR)

(72) Inventors: Sunghoon JUNG, Seoul (KR); Youngdae LEE, Seoul (KR)

(73) Assignee: LG ELECTRONICS INC., Seoul (KR)

(21) Appl. No.: 15/754,986

(22) PCT Filed: Aug. 24, 2016
(86) PCT No.: PCT/KR2016/009380

§ 371 Date: Feb. 23, 2018

Related U.S. Application Data
(60) Provisional application No. 62/209,316, filed on Aug. 24, 2015.

(51) Int. Cl. H04W 76/27; H04W 68/00; H04W 36/08

(52) U.S. Cl. CPC H04W 76/27; H04W 84/042; H04W 36/08; H04W 68/005

(57) ABSTRACT

The present invention provides a method for transmitting a radio resource control (RRC) message, which is performed by a terminal in a wireless communication system, the method comprising: determining whether to transmit an RRC message; and transmitting the RRC message if it is determined that the RRC message is to be transmitted, wherein the RRC message includes information indicating call importance having caused the transmission of the RRC message.

### BACKGROUND OF THE INVENTION

### Field of the Invention

The present invention relates to wireless communication, and more particularly, to a call prioritization method performed by a user device in a wireless communication system and the user device performing the method.

### Related Art

In the International Telecommunication Union Radio Communication sector (ITU-R), standardization of International Mobile Telecommunication (IMT)-Advanced, which is a next generation mobile communication system after 3rd generation, is underway. IMT-Advanced aims to support IP (Internet Protocol) based multimedia service at a data transfer rate of 1 Gbps in a stationary and low-speed moving state, and at a data transfer rate of 100 Mbps in a high-speed moving state.

The 3rd Generation Partnership Project (3GPP) is preparing, as a system standard meeting the requirements of IMT-Advanced, the LTE-Advanced (LTE-A), an improved version of LTE (Long Term Evolution), based on OFDMA (Orthogonal Frequency Division Multiple Access)/SC-FDMA (Single Carrier-Frequency Division Multiple Access) transmission scheme. LTE-A is one of the strong candidates for IMT-Advanced.

The user device may transmit a connection establishment request message to the network to perform communication with the base station. In this connection, all connection establishment request messages that the user device transmits to the network do not have the same importance. That is, the connection establishment request messages transmitted by the user device to the network includes a connection establishment request message for a call having a high importance (that is, a high priority) and a connection establishment request messages for a call with a low importance (that is, low priority).

Although, as described above, all of the connection establishment requests transmitted by the user device do not have the same importance, the user device does not transmit information indicating whether the connection establishment request is a connection establishment request for an important call (e.g., VoLTE call). Accordingly, the network may not know whether the connection establishment request received from the user device by the network is a connection establishment request regarding an important call (for example, VoLTE call) (or for an important call).

For this reason, the network may not determine the importance between the connection establishment request for the important call and the connection establishment request for the non-important call. This allows the network to reject the connection establishment request for the important call.

Hereinafter, in order to solve the above problems, a method is suggested by which, when the user device performs a connection establishment request to the network, the user device additionally provides information indicating that the connection establishment request is a connection establishment request related to the important call. Further, the user device configured to perform the method will be suggested.

### SUMMARY OF THE INVENTION

The present invention provides a RRC connection request message transmission method performed by a user device in a wireless communication system, and a user device performing the method.

In an aspect, a method for transmitting a Radio Resource Control (RRC) message by a user equipment (UE) in a wireless communication system is provided. The method may comprise determining whether to transmit a RRC message, and transmitting the RRC message upon determination to transmit the RRC message. The RRC message may include information indicating importance of a call that has caused the RRC message transmission.

Determining whether to transmit the RRC message may comprise determining whether to perform RRC connection establishment. The RRC message may be an RRC connection request message. The information indicating the importance of the call may be information indicating importance of a call that has caused the RRC connection establishment.

Determining whether to perform the RRC connection establishment may comprise receiving a paging message, wherein transmitting the RRC connection request message includes transmitting the RRC connection request message based on the received paging message.

The paging message may include the information indicating the importance of the call.

The information indicating the importance of the call that has caused the RRC connection establishment may be determined based on the information indicating the importance of the call included in the paging message.

The information indicating the importance of the call may be included in a paging recode of the paging message.

When the information indicating the importance of the call is not included in the paging message, the call may have normal importance or normal priority.

The information indicating the importance of the call may include information indicating that the call has high importance or high priority.

Determining whether to perform the RRC connection establishment may comprise determining whether a Mobile Originated (MO) call occurs, transmitting the RRC connection request message includes transmitting the RRC connection request message when the MO call occurs.

The information indicating the importance of the call that has caused the RRC connection establishment may include information indicating a priority of the call that has caused the RRC connection establishment.

The information indicating the importance of the call that has caused the RRC connection establishment may include information about a service category.

The call may be a Voice over LTE (VoLTE) call.

The RRC message may be an RRC connection completion message.

The method may further comprise receiving information indicating whether to send the RRC message before the RRC connection or after the RRC connection.

In another aspect, a user equipment (UE) is provided. The method may comprise a radio frequency (RF) unit configured for transmitting and receiving a radio signal, and a processor operatively coupled to the RF unit. The processor may be configured for determining whether to transmit a RRC message, and controlling the RF unit to transmit the RRC message upon determination to transmit the RRC message. The RRC message may include information indicating importance of a call that has caused the RRC message transmission.

In accordance with one embodiment of the present invention, there is provided a RRC connection request message transmission method performed by a user device in a wireless communication system, and a user device performing the method.

In accordance with one embodiment of the present invention, the user device may transmit an RRC connection request message to the network. In this connection, the user device may include information indicating the importance of the RRC connection establishment that caused the RRC connection request message transmission in the RRC connection request message. Thus, the network may determine the importance between the connection establishment request for the important call and the connection establishment request for the non-important call. This maximizes the efficiency of wireless communication by ensuring that the network does not reject the connection establishment requests for important calls.

### BRIEF DESCRIPTION OF THE DRAWINGS

FIG. 1 shows a wireless communication system to which the present invention is applied.

FIG. 2 is a diagram showing a wireless protocol architecture for a user plane.

FIG. 3 is a diagram showing a wireless protocol architecture for a control plane.

FIG. 4 is a flowchart illustrating the operation of UE in the RRC idle state.

FIG. 5 is a flowchart illustrating a procedure of establishing RRC connection.

FIG. 6 is a flowchart illustrating an RRC connection reconfiguration procedure.

FIG. 7 is a diagram illustrating an RRC connection re-establishment procedure.

FIG. 8 illustrates sub states where the terminal may have in an RRC_IDLE state and a sub state transition process.

FIG. 9 is a sequence of a method for transmitting information indicating the importance of a call via an RRC message according to one embodiment of the present invention.

FIG. 10 is a sequence of a method for transmitting information indicating the importance of a call via an RRC connection request message according to an embodiment of the present invention.

FIG. 11 is a flowchart illustrating a method for transmitting information indicating the importance of a call via an RRC connection request message based on a paging message according to an embodiment of the present invention.

FIG. 12 is the flowchart of the method of transmitting information indicating the importance of the call via the RRC connection request message when an MO call occurs, in accordance with one embodiment.

FIG. 13 is a sequence of a method for transmitting information indicating the importance of a call via an RRC connection completion message according to one embodiment of the present invention.

FIG. 14 is a block diagram illustrating the user device in which an embodiment of the present invention is implemented.

### DESCRIPTION OF EXEMPLARY EMBODIMENTS

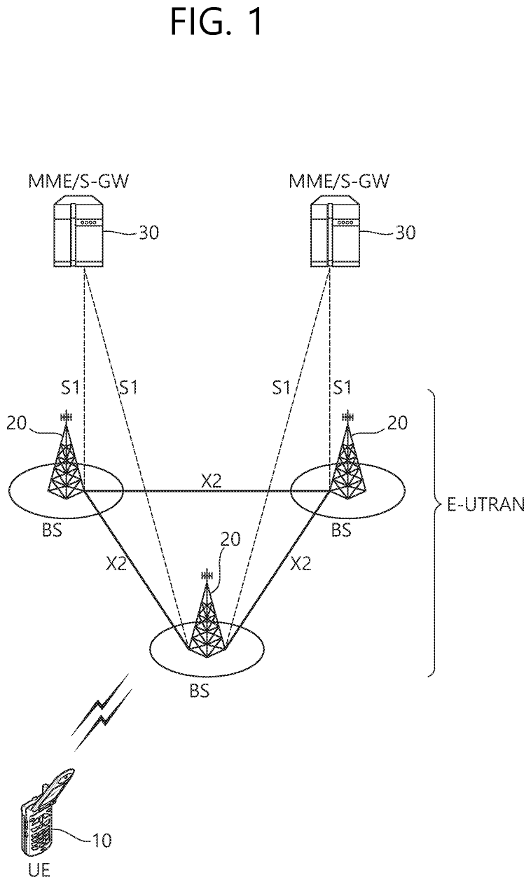

FIG. 1 shows a wireless communication system to which the present invention is applied. The wireless communication system may also be referred to as an evolved-UMTS terrestrial radio access network (E-UTRAN) or a long term evolution (LTE)/LTE-A system.

The E-UTRAN includes at least one base station (BS) 20 which provides a control plane and a user plane to a user equipment (UE) 10. The UE 10 may be fixed or mobile, and may be referred to as another terminology, such as a mobile station (MS), a user terminal (UT), a subscriber station (SS), a mobile terminal (MT), a wireless device, etc. The BS 20 is generally a fixed station that communicates with the UE 10 and may be referred to as another terminology, such as an evolved node-B (eNB), a base transceiver system (BTS), an access point, etc.

The BSs 20 are interconnected by means of an X2 interface. The BSs 20 are also connected by means of an S1 interface to an evolved packet core (EPC) 30, more specifically, to a mobility management entity (MME) through S1-MME and to a serving gateway (S-GW) through S1-U.

The EPC 30 includes an MME, an S-GW, and a packet data network-gateway (P-GW). The MME has access information of the UE or capability information of the UE, and such information is generally used for mobility management of the UE. The S-GW is a gateway having an E-UTRAN as an end point. The P-GW is a gateway having a PDN as an end point.

Layers of a radio interface protocol between the UE and the network can be classified into a first layer (L1), a second layer (L2), and a third layer (L3) based on the lower three layers of the open system interconnection (OSI) model that is well-known in the communication system. Among them, a physical (PHY) layer belonging to the first layer provides an information transfer service by using a physical channel, and a radio resource control (RRC) layer belonging to the third layer serves to control a radio resource between the UE and the network. For this, the RRC layer exchanges an RRC message between the UE and the BS.

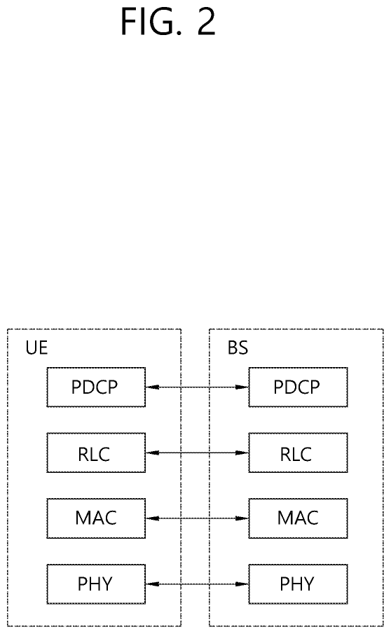

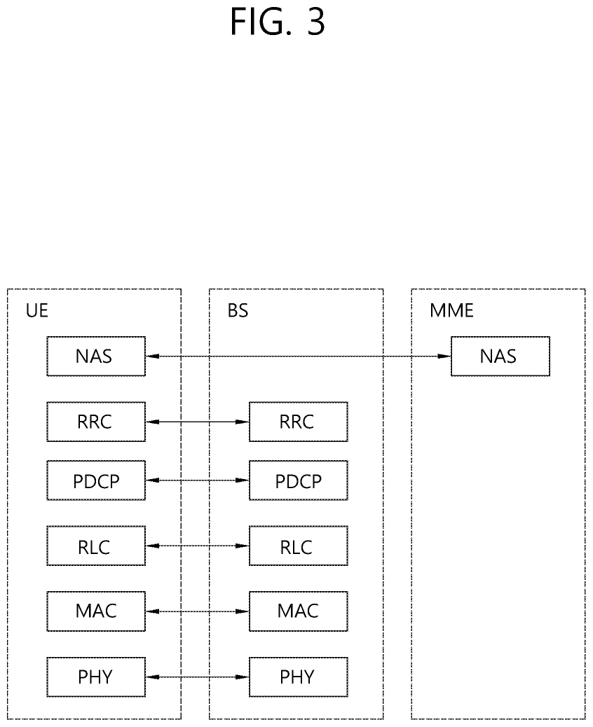

FIG. 2 is a diagram showing a wireless protocol architecture for a user plane. FIG. 3 is a diagram showing a wireless protocol architecture for a control plane. The user plane is a protocol stack for user data transmission. The control plane is a protocol stack for control signal transmission.

Referring to FIGS. 2 and 3, a PHY layer provides an upper layer with an information transfer service through a physical channel. The PHY layer is connected to a medium access control (MAC) layer which is an upper layer of the PHY layer through a transport channel. Data is transferred between the MAC layer and the PHY layer through the transport channel. The transport channel is classified according to how and with what characteristics data is transferred through a radio interface.

Data is moved between different PHY layers, that is, the PHY layers of a transmitter and a receiver, through a physical channel. The physical channel may be modulated according to an Orthogonal Frequency Division Multiplexing (OFDM) scheme, and use the time and frequency as radio resources.

The functions of the MAC layer include mapping between a logical channel and a transport channel and multiplexing and demultiplexing to a transport block that is provided through a physical channel on the transport channel of a MAC Service Data Unit (SDU) that belongs to a logical channel. The MAC layer provides service to a Radio Link Control (RLC) layer through the logical channel.

The functions of the RLC layer include the concatenation, segmentation, and reassembly of an RLC SDU. In order to guarantee various types of Quality of Service (QoS) required by a Radio Bearer (RB), the RLC layer provides three types of operation mode: Transparent Mode (TM), Unacknowledged Mode (UM), and Acknowledged Mode (AM). AM RLC provides error correction through an Automatic Repeat Request (ARQ).

The RRC layer is defined only on the control plane. The RRC layer is related to the configuration, reconfiguration, and release of radio bearers, and is responsible for control of logical channels, transport channels, and PHY channels. An RB means a logical route that is provided by the first layer (PHY layer) and the second layers (MAC layer, the RLC layer, and the PDCP layer) in order to transfer data between UE and a network.

The function of a Packet Data Convergence Protocol (PDCP) layer on the user plane includes the transfer of user data and header compression and ciphering. The function of the PDCP layer on the user plane further includes the transfer and encryption/integrity protection of control plane data.

What an RB is configured means a procedure of defining the characteristics of a wireless protocol layer and channels in order to provide specific service and configuring each detailed parameter and operating method. An RB can be divided into two types of a Signaling RB (SRB) and a Data RB (DRB). The SRB is used as a passage through which an RRC message is transmitted on the control plane, and the DRB is used as a passage through which user data is transmitted on the user plane.

If RRC connection is established between the RRC layer of UE and the RRC layer of an E-UTRAN, the UE is in the RRC connected state. If not, the UE is in the RRC idle state.

A downlink transport channel through which data is transmitted from a network to UE includes a broadcast channel (BCH) through which system information is transmitted and a downlink shared channel (SCH) through which user traffic or control messages are transmitted. Traffic or a control message for downlink multicast or broadcast service may be transmitted through the downlink SCH, or may be transmitted through an additional downlink multicast channel (MCH). Meanwhile, an uplink transport channel through which data is transmitted from UE to a network includes a random access channel (RACH) through which an initial control message is transmitted and an uplink shared channel (SCH) through which user traffic or control messages are transmitted.

Logical channels that are placed over the transport channel and that are mapped to the transport channel include a broadcast control channel (BCCH), a paging control channel (PCCH), a common control channel (CCCH), a multicast control channel (MCCH), and a multicast traffic channel (MTCH).

The physical channel includes several OFDM symbols in the time domain and several subcarriers in the frequency domain. One subframe includes a plurality of OFDM symbols in the time domain. An RB is a resources allocation unit, and includes a plurality of OFDM symbols and a plurality of subcarriers. Furthermore, each subframe may use specific subcarriers of specific OFDM symbols (e.g., the first OFDM symbol) of the corresponding subframe for a physical downlink control channel (PDCCH), that is, an L1/L2 control channel. A Transmission Time Interval (TTI) is a unit time for subframe transmission.

The RRC state of UE and an RRC connection method are described below.

The RRC state means whether or not the RRC layer of UE is logically connected to the RRC layer of the E-UTRAN. A case where the RRC layer of UE is logically connected to the RRC layer of the E-UTRAN is referred to as an RRC connected state. A case where the RRC layer of UE is not logically connected to the RRC layer of the E-UTRAN is referred to as an RRC idle state. The E-UTRAN may check the existence of corresponding UE in the RRC connected state in each cell because the UE has RRC connection, so the UE may be effectively controlled. In contrast, the E-UTRAN is unable to check UE in the RRC idle state, and a Core Network (CN) manages UE in the RRC idle state in each tracking area, that is, the unit of an area greater than a cell. That is, the existence or non-existence of UE in the RRC idle state is checked only for each large area. Accordingly, the UE needs to shift to the RRC connected state in order to be provided with common mobile communication service, such as voice or data.

When a user first powers UE, the UE first searches for a proper cell and remains in the RRC idle state in the corresponding cell. The UE in the RRC idle state establishes RRC connection with an E-UTRAN through an RRC connection procedure when it is necessary to set up the RRC connection, and shifts to the RRC connected state. A case where UE in the RRC idle state needs to set up RRC connection includes several cases. For example, the cases may include a need to send uplink data for a reason, such as a call attempt by a user, and to send a response message as a response to a paging message received from an E-UTRAN.

A Non-Access Stratum (NAS) layer placed over the RRC layer performs functions, such as session management and mobility management.

In the NAS layer, in order to manage the mobility of UE, two types of states: EPS Mobility Management-REGISTERED (EMM-REGISTERED) and EMM-DEREGISTERED are defined. The two states are applied to UE and the MME. UE is initially in the EMM-DEREGISTERED state. In order to access a network, the UE performs a procedure of registering it with the corresponding network through an initial attach procedure. If the attach procedure is successfully performed, the UE and the MME become the EMM-REGISTERED state.

In order to manage signaling connection between UE and the EPC, two types of states: an EPS Connection Management (ECM)-IDLE state and an ECM-CONNECTED state are defined. The two states are applied to UE and the MME. When the UE in the ECM-IDLE state establishes RRC connection with the E-UTRAN, the UE becomes the ECM-CONNECTED state. The MME in the ECM-IDLE state becomes the ECM-CONNECTED state when it establishes S1 connection with the E-UTRAN. When the UE is in the ECM-IDLE state, the E-UTRAN does not have information about the context of the UE. Accordingly, the UE in the ECM-IDLE state performs procedures related to UE-based mobility, such as cell selection or cell reselection, without a need to receive a command from a network. In contrast, when the UE is in the ECM-CONNECTED state, the mobility of the UE is managed in response to a command from a network. If the location of the UE in the ECM-IDLE state is different from a location known to the network, the UE informs the network of its corresponding location through a tracking area update procedure.

System information is described below.

System information includes essential information that needs to be known by UE in order for the UE to access a BS. Accordingly, the UE needs to have received all pieces of system information before accessing the BS, and needs to always have the up-to-date system information. Furthermore, the BS periodically transmits the system information because the system information is information that needs to be known by all UEs within one cell. The system information is divided into a Master Information Block (MIB) and a plurality of System Information Blocks (SIBs).

The MIB may include a limited number of parameters that are most essential and most frequently transmitted when other information is required to be obtained from a cell. UE first searches for an MIB after downlink synchronization. The MIB may include information, such as an SFN that supports downlink channel bandwidth, a PHICH configuration, and synchronization and operates as a timing criterion and an eNB transmit antenna configuration. The MIB may be transmitted on a broadcast channel (BCH) through broadcasting.

SystemInformationBlockType1 (SIB1) of included SIBs is included in a “SystemInformationBlockType1” message and transmitted. The remaining SIBs other than the SIB1 is included in a system information message and transmitted. To map the SIBs to the system information message may be flexibly configured by a scheduling information list parameter included in the SIB1. In this case, each of the SIBs is included in a single system information message, and only SIBs having the same scheduling requirement value (e.g. cycle) may be mapped to the same system information message. Furthermore, a SystemInformationBlockType2 (SIB2) is always mapped to a system information message corresponding to the first entry within the system information message list of a scheduling information list. A plurality of system information messages may be transmitted within the same cycle. The SIB1 and all the system information messages are transmitted on a DL-SCH.

In addition to broadcast transmission, in an E-UTRAN, the SIB1 may be dedicated-signaled in the state in which it includes a parameter configured like an existing configured value. In this case, the SIB1 may be included in an RRC connection reconfiguration message and transmitted.

The SIB1 includes information related to UE cell access, and defines the scheduling of other SIBs. The SIB1 may include information related to the PLMN identifiers of a network, tracking area code (TAC) and a cell ID, a cell barring status indicative of whether a cell is a cell on which camp-on is possible, the lowest reception level required within a cell which is used as cell reselection criterion, and the transmission time and cycle of other SIBs.

The SIB2 may include radio resource configuration information common to all pieces of UE. The SIB2 may include information related to an uplink carrier frequency and uplink channel bandwidth, an RACH configuration, a page configuration, an uplink power control configuration, a sounding reference signal configuration, a PUCCH configuration supporting ACK/NACK transmission, and a PUSCH configuration.

UE may apply a procedure for obtaining system information and detecting a change of system information to a primary cell (PCell) only. In a secondary cell (SCell), when a corresponding SCell is added, an E-UTRAN may provide all of pieces of system information related to an RRC connection state operation through dedicated signaling. When system information related to a configured SCell is changed, an E-UTRAN may release an SCell that is taken into consideration and subsequently add the changed system information. This may be performed along with a single RRC connection reconfiguration message. An E-UTRAN may configure parameter values different from a value broadcasted within an SCell that has been taken into consideration through dedicated signaling.

UE needs to guarantee the validity of a specific type of system information, and such system information is called required system information. The required system information may be defined as follows.
If UE is an RRC idle state: The UE needs to be guaranteed so that it has the valid versions of the MIB and the SIB1 in addition to the SIB2 to SIB8. This may comply with the support of a radio access technology (RAT) that is taken into consideration.
If UE is an RRC connection state: The UE needs to be guaranteed so that it has the valid versions of the MIB, the SIB1, and the SIB2.

In general, the validity of system information may be guaranteed up to a maximum of 3 hours after the system information is obtained.

In general, service that is provided to UE by a network may be classified into three types as follows. Furthermore, the UE differently recognizes the type of cell depending on what service may be provided to the UE. In the following description, a service type is first described, and the type of cell is described.

1) Limited service: this service provides emergency calls and an Earthquake and Tsunami Warning System (ETWS), and may be provided by an acceptable cell.

2) Suitable service: this service means public service for common uses, and may be provided by a suitable cell (or a normal cell).

3) Operator service: this service means service for communication network operators. This cell may be used by only communication network operators, but may not be used by common users.

In relation to a service type provided by a cell, the type of cell may be classified as follows.

1) An acceptable cell: this cell is a cell from which UE may be provided with limited service. This cell is a cell that has not been barred from a viewpoint of corresponding UE and that satisfies the cell selection criterion of the UE.

2) A suitable cell: this cell is a cell from which UE may be provided with suitable service. This cell satisfies the conditions of an acceptable cell and also satisfies additional conditions. The additional conditions include that the suitable cell needs to belong to a Public Land Mobile Network (PLMN) to which corresponding UE may access and that the suitable cell is a cell on which the execution of a tracking area update procedure by the UE is not barred. If a corresponding cell is a CSG cell, the cell needs to be a cell to which UE may access as a member of the CSG.

3) A barred cell: this cell is a cell that broadcasts information indicative of a barred cell through system information.

4) A reserved cell: this cell is a cell that broadcasts information indicative of a reserved cell through system information.

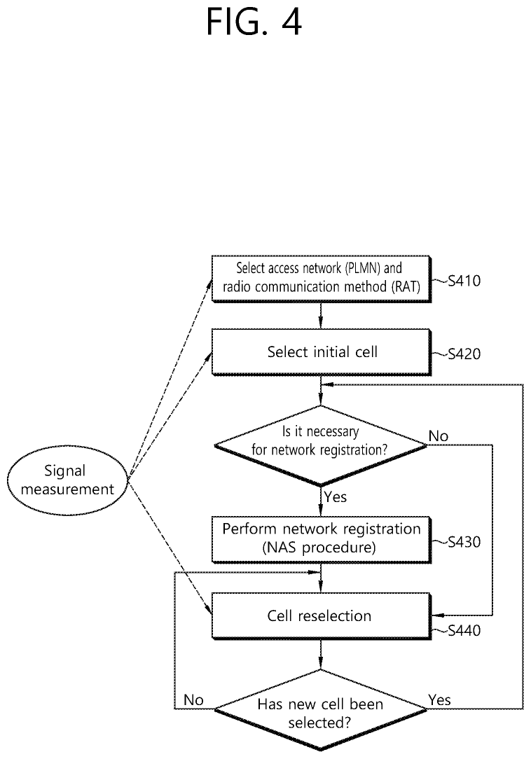

FIG. 4 is a flowchart illustrating the operation of UE in the RRC idle state. FIG. 4 illustrates a procedure in which UE that is initially powered on experiences a cell selection procedure, registers it with a network, and then performs cell reselection if necessary.

Referring to FIG. 4, the UE selects Radio Access Technology (RAT) in which the UE communicates with a Public Land Mobile Network (PLMN), that is, a network from which the UE is provided with service (S410). Information about the PLMN and the RAT may be selected by the user of the UE, and the information stored in a Universal Subscriber Identity Module (USIM) may be used.

The UE selects a cell that has the greatest value and that belongs to cells having measured BS and signal intensity or quality greater than a specific value (cell selection) (S420). In this case, the UE that is powered off performs cell selection, which may be called initial cell selection. A cell selection procedure is described later in detail. After the cell selection, the UE receives system information periodically by the BS. The specific value refers to a value that is defined in a system in order for the quality of a physical signal in data transmission/reception to be guaranteed. Accordingly, the specific value may differ depending on applied RAT.

If network registration is necessary, the UE performs a network registration procedure (S430). The UE registers its information (e.g., an IMSI) with the network in order to receive service (e.g., paging) from the network. The UE does not register it with a network whenever it selects a cell, but registers it with a network when information about the network (e.g., a Tracking Area Identity (TAI)) included in system information is different from information about the network that is known to the UE.

The UE performs cell reselection based on a service environment provided by the cell or the environment of the UE (S440). If the value of the intensity or quality of a signal measured based on a BS from which the UE is provided with service is lower than that measured based on a BS of a neighboring cell, the UE selects a cell that belongs to other cells and that provides better signal characteristics than the cell of the BS that is accessed by the UE. This procedure is called cell reselection differently from the initial cell selection of the No. 2 procedure. In this case, temporal restriction conditions are placed in order for a cell to be frequently reselected in response to a change of signal characteristic. A cell reselection procedure is described later in detail.

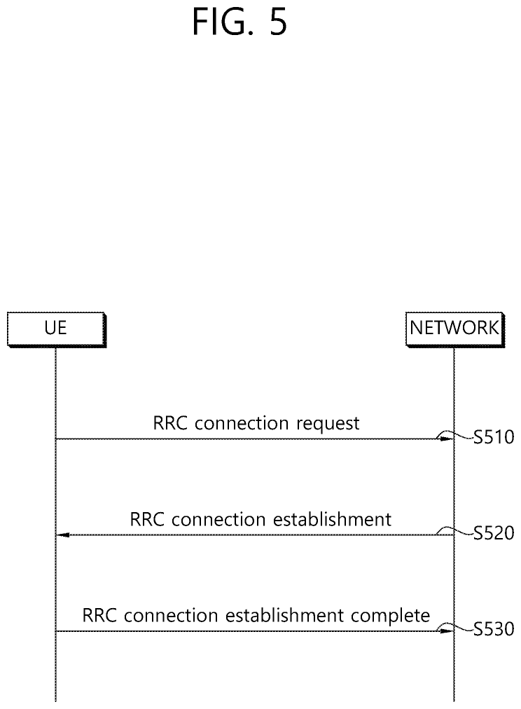

FIG. 5 is a flowchart illustrating a procedure of establishing RRC connection.

UE sends an RRC connection request message that requests RRC connection to a network (S510). The network sends an RRC connection establishment message as a response to the RRC connection request (S520). After receiving the RRC connection establishment message, the UE enters RRC connected mode.

The UE sends an RRC connection establishment complete message used to check the successful completion of the RRC connection to the network (S530).

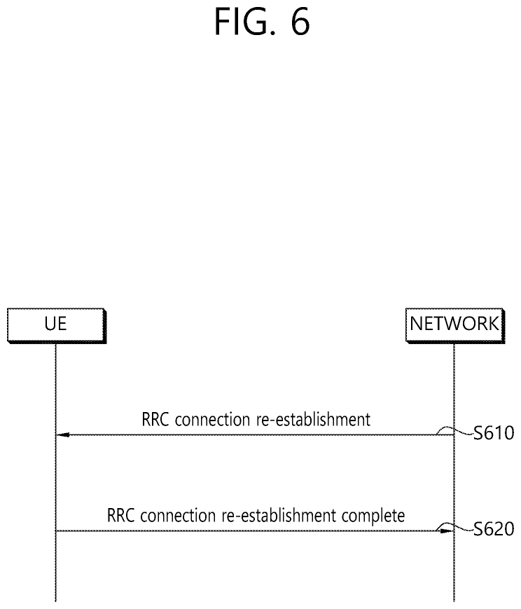

FIG. 6 is a flowchart illustrating an RRC connection reconfiguration procedure. An RRC connection reconfiguration is used to modify RRC connection. This is used to establish/modify/release RBs, perform handover, and set up/modify/release measurements.

A network sends an RRC connection reconfiguration message for modifying RRC connection to UE (S610). As a response to the RRC connection reconfiguration message, the UE sends an RRC connection reconfiguration complete message used to check the successful completion of the RRC connection reconfiguration to the network (S620).

Hereinafter, a public land mobile network (PLMN) is described.

The PLMN is a network which is disposed and operated by a mobile network operator. Each mobile network operator operates one or more PLMNs. Each PLMN may be identified by a Mobile Country Code (MCC) and a Mobile Network Code (MNC). PLMN information of a cell is included in system information and broadcasted.

In PLMN selection, cell selection, and cell reselection, various types of PLMNs may be considered by the terminal.

Home PLMN (HPLMN): PLMN having MCC and MNC matching with MCC and MNC of a terminal IMSI.

Equivalent HPLMN (EHPLMN): PLMN serving as an equivalent of an HPLMN.

Registered PLMN (RPLMN): PLMN successfully finishing location registration.

Equivalent PLMN (EPLMN): PLMN serving as an equivalent of an RPLMN.

Each mobile service consumer subscribes in the HPLMN. When a general service is provided to the terminal through the HPLMN or the EHPLMN, the terminal is not in a roaming state. Meanwhile, when the service is provided to the terminal through a PLMN except for the HPLMN/EHPLMN, the terminal is in the roaming state. In this case, the PLMN refers to a Visited PLMN (VPLMN).

When UE is initially powered on, the UE searches for available Public Land Mobile Networks (PLMNs) and selects a proper PLMN from which the UE is able to be provided with service. The PLMN is a network that is deployed or operated by a mobile network operator. Each mobile network operator operates one or more PLMNs. Each PLMN may be identified by Mobile Country Code (MCC) and Mobile Network Code (MNC). Information about the PLMN of a cell is included in system information and broadcasted. The UE attempts to register it with the selected PLMN. If registration is successful, the selected PLMN becomes a Registered PLMN (RPLMN). The network may signalize a PLMN list to the UE. In this case, PLMNs included in the PLMN list may be considered to be PLMNs, such as RPLMNs. The UE registered with the network needs to be able to be always reachable by the network. If the UE is in the ECM-CONNECTED state (identically the RRC connection state), the network recognizes that the UE is being provided with service. If the UE is in the ECM-IDLE state (identically the RRC idle state), however, the situation of the UE is not valid in an eNB, but is stored in the MME. In such a case, only the MME is informed of the location of the UE in the ECM-IDLE state through the granularity of the list of Tracking Areas (TAs). A single TA is identified by a Tracking Area Identity (TAI) formed of the identifier of a PLMN to which the TA belongs and Tracking Area Code (TAC) that uniquely expresses the TA within the PLMN.

Thereafter, the UE selects a cell that belongs to cells provided by the selected PLMN and that has signal quality and characteristics on which the UE is able to be provided with proper service.

The following is a detailed description of a procedure of selecting a cell by a terminal.

When power is turned-on or the terminal is located in a cell, the terminal performs procedures for receiving a service by selecting/reselecting a suitable quality cell.

A terminal in an RRC idle state should prepare to receive a service through the cell by always selecting a suitable quality cell. For example, a terminal where power is turned-on just before should select the suitable quality cell to be registered in a network. If the terminal in an RRC connection state enters in an RRC idle state, the terminal should selects a cell for stay in the RRC idle state. In this way, a procedure of selecting a cell satisfying a certain condition by the terminal in order to be in a service idle state such as the RRC idle state refers to cell selection. Since the cell selection is performed in a state that a cell in the RRC idle state is not currently determined, it is important to select the cell as rapid as possible. Accordingly, if the cell provides a wireless signal quality of a predetermined level or greater, although the cell does not provide the best wireless signal quality, the cell may be selected during a cell selection procedure of the terminal.

A method and a procedure of selecting a cell by a terminal in a 3GPP LTE is described with reference to 3GPP TS 36.304 V8.5.0 (2009-03) “User Equipment (UE) procedures in idle mode (Release 8)”.

A cell selection procedure is basically divided into two types.

The first is an initial cell selection procedure. In this procedure, UE does not have preliminary information about a wireless channel. Accordingly, the UE searches for all wireless channels in order to find out a proper cell. The UE searches for the strongest cell in each channel. Thereafter, if the UE has only to search for a suitable cell that satisfies a cell selection criterion, the UE selects the corresponding cell.

Next, the UE may select the cell using stored information or using information broadcasted by the cell. Accordingly, cell selection may be fast compared to an initial cell selection procedure. If the UE has only to search for a cell that satisfies the cell selection criterion, the UE selects the corresponding cell. If a suitable cell that satisfies the cell selection criterion is not retrieved though such a procedure, the UE performs an initial cell selection procedure.

A cell selection criterion may be defined as in Equation 1 below. Following Equation 1 can be referred to as measurement for determining whether or not S-criterion is satisfied.

Srxlev>0 AND Squal>0. [Equation 1]

where:

Srxlev=Qᵣₓₗₑᵥₘₑₐₛ−(Qᵣₓₗₑᵥₘᵢₙ+Q_{rxlevminoffset})−P_{compensation},

Squal=Q_{qualmeas}−(Q_{qualmin}+Q_{qualminoffset})

In this case, in Equation 1, the variables may be defined as in Table 1 below.

TABLE 1

| | |
|---|---|
| Srxlev | Cell selection RX level value (dB) |
| Squal | Cell selection quality value (dB) |
| Qᵣₓₗₑᵥₘₑₐₛ | Measured cell RX level value (RSRP) |
| Q_{qualmeas} | Measured cell quality value (RSRQ) |
| Qᵣₓₗₑᵥₘᵢₙ | Minimum required RX level in the cell (dBm) |
| Q_{qualmin} | Minimum required quality level in the cell (dB) |
| Q_{rxlevminoffset} | Offset to the signalled Qᵣₓₗₑᵥₘᵢₙ taken into account in the |
| | Srxlev evaluation as a result of a periodic search for a |
| | higher priority PLMN while camped normally in a |
| | VPLMN |
| Q_{qualminoffset} | Offset to the signalled Q_{qualmin} taken into account in the |
| | Squal evaluation as a result of a periodic search for a |
| | higher priority PLMN while camped normally in a |
| | VPLMN |
| Pcompensation | max(P_{EMAX} − P_{PowerClass}, 0) (dB) |
| P_{EMAX} | Maximum TX power level an UE may use when |
| | transmitting on the uplink in the cell (dBm) defined as |
| | P_{EMAX} in [TS 36.101] |
| P_{PowerClass} | Maximum RF output power of the UE (dBm) according |
| | to the UE power class as defined in [TS 36.101] |

Qrxlevminoffset and Qqualminoffset, that is, signaled values, are the results of periodic discovery for a PLMN having higher priority while UE camps on a normal cell within a VPLMN, and may be applied only when cell selection is evaluated. As described above, during the periodic discovery of a PLMN having higher priority, UE may perform cell selection evaluation using parameter values stored from another cell of the PLMN having such higher priority.

After UE selects any cell through a cell selection procedure, the intensity or quality of a signal between the UE and a BS may be changed due to the mobility of the UE or a change of a radio environment. Accordingly, if the quality of the selected cell is changed, the UE may select another cell providing better quality.

After the UE selects a specific cell through the cell selection procedure, the intensity or quality of a signal between the UE and a BS may be changed due to a change in the mobility or wireless environment of the UE. Accordingly, if the quality of the selected cell is deteriorated, the UE may select another cell that provides better quality. If a cell is reselected as described above, the UE selects a cell that provides better signal quality than the currently selected cell. Such a procedure is called cell reselection. In general, a basic object of the cell reselection procedure is to select a cell that provides UE with the best quality from a viewpoint of the quality of a radio signal.

In addition to the viewpoint of the quality of a radio signal, a network may determine priority corresponding to each frequency, and may inform the UE of the determined priorities. The UE that has received the priorities preferentially takes into consideration the priorities in a cell reselection procedure compared to a radio signal quality criterion.

As described above, there is a method of selecting or reselecting a cell according to the signal characteristics of a wireless environment. In selecting a cell for reselection when a cell is reselected, the following cell reselection methods may be present according to the RAT and frequency characteristics of the cell.
Intra-frequency cell reselection: UE reselects a cell having the same center frequency as that of RAT, such as a cell on which the UE camps on.
Inter-frequency cell reselection: UE reselects a cell having a different center frequency from that of RAT, such as a cell on which the UE camps on
Inter-RAT cell reselection: UE reselects a cell that uses RAT different from RAT on which the UE camps

The principle of a cell reselection procedure is as follows.

First, UE measures the quality of a serving cell and neighbor cells for cell reselection.

Second, cell reselection is performed based on a cell reselection criterion. The cell reselection criterion has the following characteristics in relation to the measurements of a serving cell and neighbor cells.

Intra-frequency cell reselection is basically based on ranking. Ranking is a task for defining a criterion value for evaluating cell reselection and numbering cells using criterion values according to the size of the criterion values. A cell having the best criterion is commonly called the best-ranked cell. The cell criterion value is based on the value of a corresponding cell measured by UE, and may be a value to which a frequency offset or cell offset has been applied, if necessary.

Inter-frequency cell reselection is based on frequency priority provided by a network. UE attempts to camp on a frequency having the highest frequency priority. A network may provide frequency priority that will be applied by UEs within a cell in common through broadcasting signaling, or may provide frequency-specific priority to each UE through UE-dedicated signaling. A cell reselection priority provided through broadcast signaling may refer to a common priority. A cell reselection priority for each terminal set by a network may refer to a dedicated priority. If receiving the dedicated priority, the terminal may receive a valid time associated with the dedicated priority together. If receiving the dedicated priority, the terminal starts a validity timer set as the received valid time together therewith. While the valid timer is operated, the terminal applies the dedicated priority in the RRC idle mode. If the valid timer is expired, the terminal discards the dedicated priority and again applies the common priority.

For the inter-frequency cell reselection, a network may provide UE with a parameter (e.g., a frequency-specific offset) used in cell reselection for each frequency. For the intra-frequency cell reselection or the inter-frequency cell reselection, a network may provide UE with a Neighboring Cell List (NCL) used in cell reselection. The NCL includes a cell-specific parameter (e.g., a cell-specific offset) used in cell reselection. For the intra-frequency or inter-frequency cell reselection, a network may provide UE with a cell reselection black list used in cell reselection.

The UE does not perform cell reselection on a cell included in the black list.

Ranking performed in a cell reselection evaluation procedure is described below.

A ranking criterion used to give the priority of a cell is defined as in Equation 2.

Rs=Qmeas,s+Qhyst, Rn=Qmeas,n−Qoffset [Equation 2]

In Equation 2, Rs is the ranking criterion of a serving cell on which UE now camps, Rn is the ranking criterion of a neighboring cell, Qmeas,s is the quality value of the serving cell measured by the UE, Qmeas,n is the quality value of the neighboring cell measured by the UE, Qhyst is a hysteresis value for ranking, and Qoffset is an offset between the two cells.

In Intra-frequency, if UE receives an offset “Qoffsets,n” between a serving cell and a neighbor cell, Qoffset=Qoffsets,n. If UE does not Qoffsets,n, Qoffset=0.

In Inter-frequency, if UE receives an offset “Qoffsets,n” for a corresponding cell, Qoffset=Qoffsets,n+Qfrequency. If UE does not receive “Qoffsets,n”, Qoffset=Qfrequency.

If the ranking criterion Rs of a serving cell and the ranking criterion Rn of a neighbor cell are changed in a similar state, ranking priority is frequency changed as a result of the change, and UE may alternately reselect the twos. Qhyst is a parameter that gives hysteresis to cell reselection so that UE is prevented from to alternately reselecting two cells.

UE measures RS of a serving cell and Rn of a neighbor cell according to the above equation, considers a cell having the greatest ranking criterion value to be the best-ranked cell, and reselects the cell.

In accordance with the criterion, it may be checked that the quality of a cell is the most important criterion in cell reselection. If a reselected cell is not a suitable cell, UE excludes a corresponding frequency or a corresponding cell from the subject of cell reselection.

Hereinafter, radio link failure (RLF) will be described.

UE continues to perform measurements in order to maintain the quality of a radio link with a serving cell from which the UE receives service. The UE determines whether or not communication is impossible in a current situation due to the deterioration of the quality of the radio link with the serving cell. If communication is almost impossible because the quality of the serving cell is too low, the UE determines the current situation to be an RLF.

If the RLF is determined, the UE abandons maintaining communication with the current serving cell, selects a new cell through cell selection (or cell reselection) procedure, and attempts RRC connection re-establishment with the new cell.

In the specification of 3GPP LTE, the following examples are taken as cases where normal communication is impossible.
A case where UE determines that there is a serious problem in the quality of a downlink communication link (a case where the quality of a PCell is determined to be low while performing RLM) based on the radio quality measured results of the PHY layer of the UE
A case where uplink transmission is problematic because a random access procedure continues to fail in the MAC sublayer.
A case where uplink transmission is problematic because uplink data transmission continues to fail in the RLC sublayer.
A case where handover is determined to have failed.
A case where a message received by UE does not pass through an integrity check.

An RRC connection re-establishment procedure is described in more detail below.

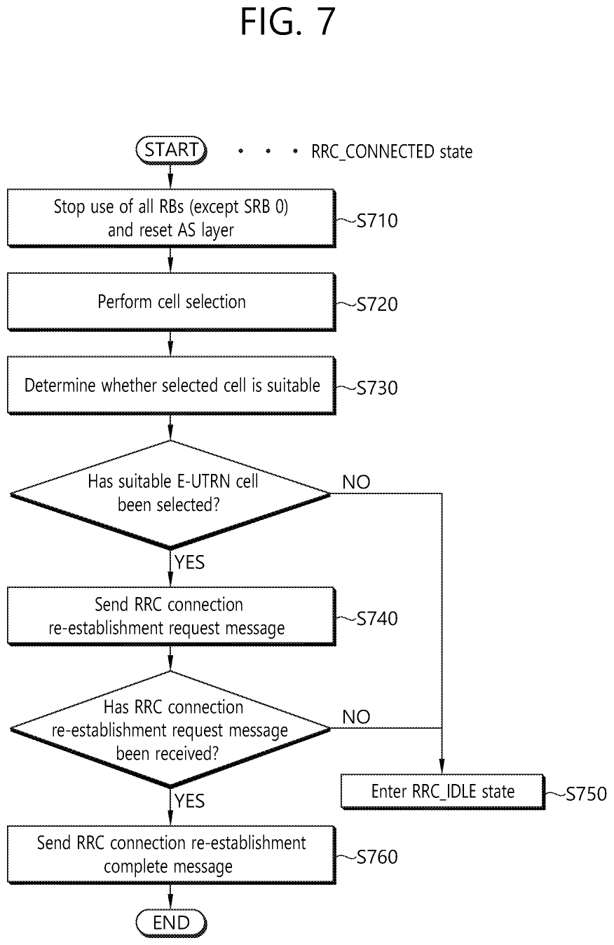

FIG. 7 is a diagram illustrating an RRC connection re-establishment procedure.

Referring to FIG. 7, UE stops using all the radio bearers that have been configured other than a Signaling Radio Bearer (SRB) #0, and initializes a variety of kinds of sublayers of an Access Stratum (AS) (S710). Furthermore, the UE configures each sublayer and the PHY layer as a default configuration. In this procedure, the UE maintains the RRC connection state.

The UE performs a cell selection procedure for performing an RRC connection reconfiguration procedure (S720). The cell selection procedure of the RRC connection re-establishment procedure may be performed in the same manner as the cell selection procedure that is performed by the UE in the RRC idle state, although the UE maintains the RRC connection state.

After performing the cell selection procedure, the UE determines whether or not a corresponding cell is a suitable cell by checking the system information of the corresponding cell (S730). If the selected cell is determined to be a suitable E-UTRAN cell, the UE sends an RRC connection re-establishment request message to the corresponding cell (S740).

Meanwhile, if the selected cell is determined to be a cell that uses RAT different from that of the E-UTRAN through the cell selection procedure for performing the RRC connection re-establishment procedure, the UE stops the RRC connection re-establishment procedure and enters the RRC idle state (S750).

The UE may be implemented to finish checking whether the selected cell is a suitable cell through the cell selection procedure and the reception of the system information of the selected cell. To this end, the UE may drive a timer when the RRC connection re-establishment procedure is started. The timer may be stopped if it is determined that the UE has selected a suitable cell. If the timer expires, the UE may consider that the RRC connection re-establishment procedure has failed, and may enter the RRC idle state. Such a timer is hereinafter called an RLF timer. In LTE spec TS 36.331, a timer named “T311” may be used as an RLF timer. The UE may obtain the set value of the timer from the system information of the serving cell.

If an RRC connection re-establishment request message is received from the UE and the request is accepted, a cell sends an RRC connection re-establishment message to the UE.

The UE that has received the RRC connection re-establishment message from the cell reconfigures a PDCP sublayer and an RLC sublayer with an SRB1. Furthermore, the UE calculates various key values related to security setting, and reconfigures a PDCP sublayer responsible for security as the newly calculated security key values. Accordingly, the SRB 1 between the UE and the cell is open, and the UE and the cell may exchange RRC control messages. The UE completes the restart of the SRB1, and sends an RRC connection re-establishment complete message indicative of that the RRC connection re-establishment procedure has been completed to the cell (S760).

In contrast, if the RRC connection re-establishment request message is received from the UE and the request is not accepted, the cell sends an RRC connection re-establishment reject message to the UE.

If the RRC connection re-establishment procedure is successfully performed, the cell and the UE perform an RRC connection reconfiguration procedure. Accordingly, the UE recovers the state prior to the execution of the RRC connection re-establishment procedure, and the continuity of service is guaranteed to the upmost.

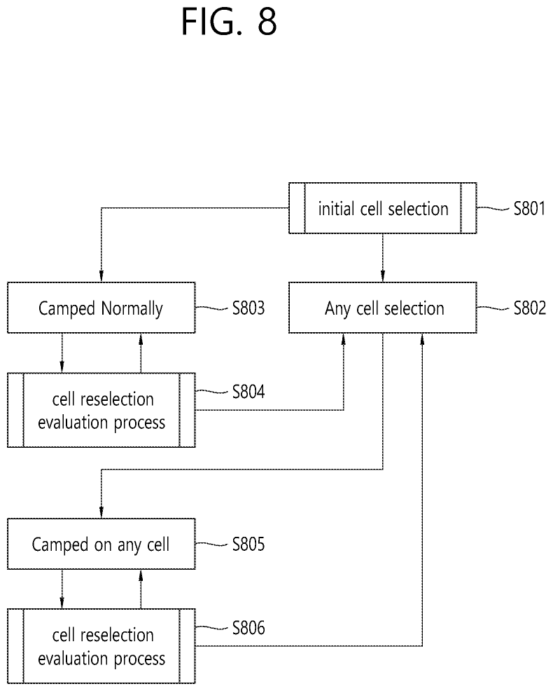

FIG. 8 illustrates sub states where the terminal may have in an RRC_IDLE state and a sub state transition process.

Referring to FIG. 8, a terminal performs an initial cell selection process (S801). The initial cell selection process may be performed when there is no stored cell information with respect to the PLMN or a suitable cell is not found.

If the suitable cell is not found in the initial cell selection process, the terminal transitions to an any cell selection state (S802). The optional cell selection state represents a state which does not camp on in both of a suitable cell and an acceptable cell. The optional cell selection state is a state attempted by the terminal in order to find an acceptable cell of an optional PLMN which may camp on. When the terminal finds no cells which may camp on, the terminal is continuously maintained in an optional cell selection state until the acceptable cell is found.

If the suitable cell is found in the initial cell selection process, the state transits to a normal camp state (S803). The normal camp state represents a state which camps on the normal cell. A paging channel is selected according to information given through system information to motor, and an evaluation process for cell reselection may be performed.

In the normal camp state (S803), if a cell reselection evaluation process (S804) is caused, the cell reselection evaluation process (S804) is performed. If a suitable cell is found in the cell reselection evaluation process (S804), the terminal again transits to the normal camp state (S803).

If an acceptable cell is found in the any cell selection state (S802), the terminal transits to an any cell camped state (S805). The any cell camped state (S805) represents a state of camping on an acceptable cell.

In the any cell camped state (S805), the terminal may select a paging channel according to information given through system information to monitor, and may perform a cell reselection evaluation process (S806). If the acceptable cell is not found in the cell reselection evaluation process (S806), the terminal transits the any cell selection state (S802).

Hereinafter, the cause of LTE call establishment will be described.

The user device may provide the following cause information (that is, LTE call establishment cause information) to the network.

| | |
|---|---|
| EstablishmentCause ::= | ENUMERATED { |

emergency, highPriorityAccess. mt-Access, mo-Signalling,
mo-Data, delayTolerantAccess-v1020, spare2, spare1}

The cause information includes the following: information on whether the cause of the LTE call is due to a Mobile Originated call (MO) (for example, mo-Signaling, mo-Data) or a Mobile Terminated call (MT) (for example, mt-Access), and information that primarily identifies the priority of an access attempt.

That is, the cause information does not include information about the call type. That is, the cause information does not include information indicating whether the call is a Voice over LTE (VoLTE) call or information indicating whether the call is a call requiring prioritization. Accordingly, the network may not distinguish the call type (that is, whether the call of interest is a VoLTE call) based on the information alone. In this connection, the MT call refers to a call made by the user device via an instruction (for example, paging) from the network to the user device to perform a call. The MO call may mean a call that the user device triggers according to a specific condition, that is, a call made by the user device.

VoLTE calls may be initiated via MT signaling (for example, paging). Alternatively, the VoLTE call may be initiated by an MO signaling (e.g., UE initiating random access).

First, in terms of MT signaling, when the network transmits the paging message to the user device, the network may not separately indicate to the device that the paging message intended to setup a VoLTE call. Then, upon receiving the paging message, the user device requests connection establishment to the network. At this time, the user device indicates to the network that the request is an mt-access-based connection establishment, but the user device does not separately indicate to the network that the request of the user device is related to the VoLTE call. Accordingly, the base station does not recognize that the call from the user device is an MT VoLTE call, prior to the RRC connection setup.

Similarly to the MO signaling, the base station does not know whether the connection establishment request from the user device is based on a VoLTE call.

The present invention will be described below.

The user device may transmit a connection establishment request message to the network to perform communication with the base station. In this connection, all connection establishment request messages that the user device transmits to the network do not have the same importance. That is, the connection establishment request messages transmitted by the user device to the network includes a connection establishment request message for a call having a high importance (that is, a high priority) and a connection establishment request messages for a call with a low importance (that is, low priority).

Although, as described above, all of the connection establishment requests transmitted by the user device do not have the same importance, the user device does not transmit information indicating whether the connection establishment request is a connection establishment request for an important call (e.g., VoLTE call). Accordingly, the network may not know whether the connection establishment request received from the user device by the network is a connection establishment request regarding an important call (for example, VoLTE call) (or for an important call).

In one example, a service provider (operator) may intend to prioritize a VoLTE call rather than a data call originating from another user device. That is, even when the network is congested due to another data service, the service provider may allow a VoLTE call or always prioritize a service provider VoLTE call compared to other calls. However, as described above, the network may not know whether the connection establishment request received from the user device is a connection establishment request related to an important call.

For this reason, the network may not determine the importance between the connection establishment request for the important call and the connection establishment request for the non-important call. This allows the network to reject the connection establishment request for the important call.

Hereinafter, in order to solve the above problems, a method is suggested by which, when the user device performs a connection establishment request to the network, the user device additionally provides information indicating that the connection establishment request is a connection establishment request related to the important call. Further, the user device configured to perform the method will be suggested.

Further, hereinafter, a method is suggested by which, in order that when the network receives a connection establishment request, the network is configured to determine whether the connection establishment request is a connection establishment request related to a non-important or important call, the base station includes specific information about a call related to the paging message in the paging message when the base station transmits the paging message to the user device. Further, the user device configured to perform the method will be suggested. Further, the present disclosure is to provide a method and device configured for including concrete information on a call related to the connection establishment request into the connection establishment request.

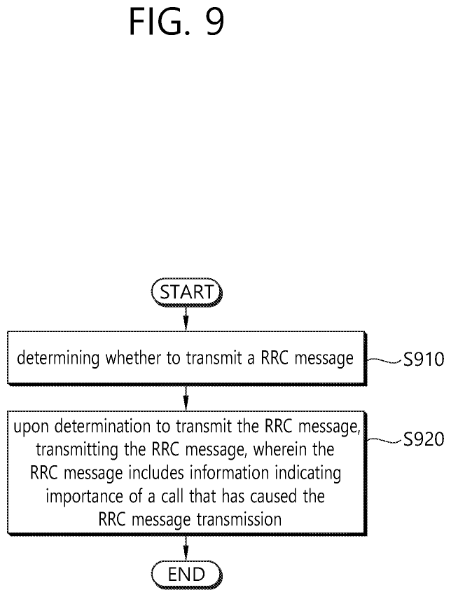

FIG. 9 is a sequence of a method for transmitting information indicating the importance of a call via an RRC message according to one embodiment of the present invention.

According to FIG. 9, the user device may determine whether to transmit a RRC message (S910). In this connection, if the RRC message is a message to be transmitted before the RRC connection completion, the RRC message may be an RRC connection request message. In this connection, if the RRC message is a message to be transmitted after the RRC connection completion, the RRC message may be an RRC connection completion message.

In this connection, a specific example in which the above-mentioned RRC message is the RRC connection request message, and a specific example in which the RRC message is an RRC connection completion message will be described later.

Thereafter, when the user device decides to transmit a RRC message, the user device may transmit an RRC message including information indicating the importance of the corresponding call (S920). A concrete example of information indicating the importance of the corresponding call, and, in this connection, a specific example in which the user device transmits the RRC message to the network, will be described later.

Hereinafter, a case when the information indicating the importance of the call is transmitted before the RRC connection establishment is completed, and a case when the information indicating the importance of the call is transmitted after the completion of the RRC connection establishment will be described.

I. Case when Information Indicating the Importance of the Call is Transmitted Before the Completion of the RRC Connection Establishment

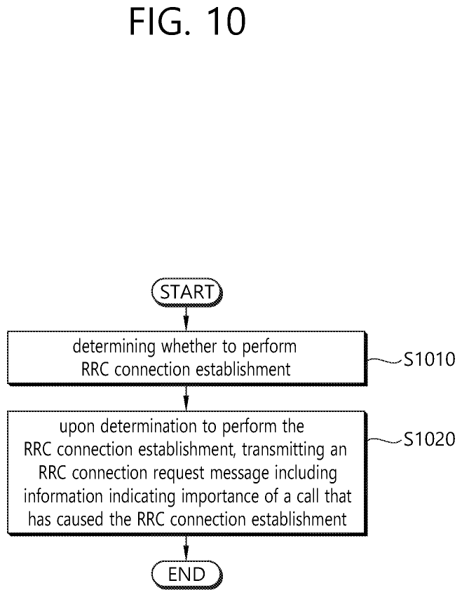

FIG. 10 is a sequence of a method for transmitting information indicating the importance of a call via an RRC connection request message according to an embodiment of the present invention.

According to FIG. 10, the user device may determine whether to perform connection establishment (S1010). That is, the user device may determine whether to perform a Radio Resource Control (RRC) connection establishment. In this connection, determining whether the user device performs connection establishment may mean determining whether the user device receives a paging message. That is, the user device may receive the paging message and thus perform connection establishment. In this connection, when the user device receives a paging message and thus performs connection establishment, it may mean that the MT call is performed. Further, determining whether or not the user device performs connection establishment may mean determining whether an MO call has occurred. That is, an MO call occurs (or is triggered) may mean that the user device performs a connection establishment. A more specific example of determining whether the user device performs connection establishment will be described later.

If the user device has decided to perform connection establishment, the user device may transmit an RRC connection request message including information indicating importance (S1020). The details of the information indicating the importance will be described later.

Hereinafter, the specific details of the paging message received by the user device, and a concrete example of including information indicating the importance of the MT call (or MO call) in the connection establishment request message (for example, RRC connection request message) will be described.

First, the case of MT call is explained.

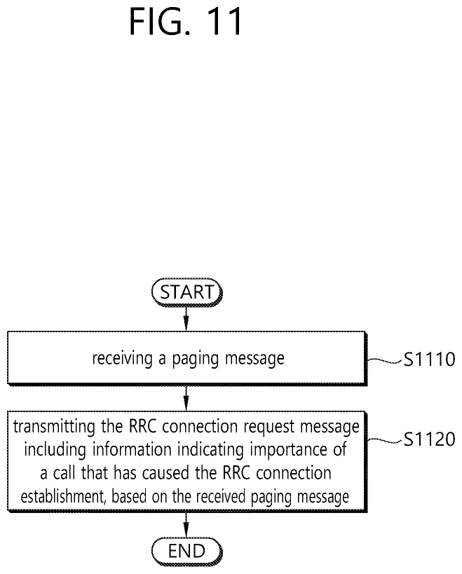

FIG. 11 is a flowchart illustrating a method for transmitting information indicating the importance of a call via an RRC connection request message based on a paging message according to an embodiment of the present invention.

According to FIG. 11, the user device may receive a paging message (S1110).

More specifically,

1. For an MT call, the paging message may indicate, via the paging recode, whether the MT call to be performed by the user device has a high priority.

The user device may receive paging messages from the network. In this regard, the paging recode of the paging message received by the user device from the network includes information indicating whether or not the user device as the paging target should perform an MT call with a high priority (or important MT call).

In this connection, the user device determines whether the user device should perform a ‘normal MT’ call or a ‘high importance MT (high priority MT)’ call based on the information contained in the paging message.

1) Information Indicating Normal MT Call

If information indicating that a call to be configured for the user device (or a call to be made by the user device) is a normal MT call is included in the paging recode of interest, the user device may decide to perform the normal MT call.

If there is no information about importance in the paging recode of interest (for example, if there is information about whether to perform a ‘general MT (normal MT)’ call or a ‘high priority (high importance MT)’ call), the user device may determine that the call to be configured for the user device (or the call to be made by the device) is a normal MT call.

2) Information Indicating High Importance MT Call

If the indicator of ‘high importance MT’ (or information indicating ‘high importance MT’) is included in the paging recode of interest, the user device may decide to perform an MT call with a high priority.

That is, the network indicates to the user device and the network itself, via the indicator of ‘high importance MT’ (or information indicating ‘high importance MT’), that the MT call that the network is interested in is an MT call with high priority (or high importance), as compared to the normal (or another) MT call. In this connection, a concrete example in which the network indicates to the network itself, via the indicator of ‘high importance MT’ (or information indicating ‘high importance MT’), that the MT call that the network is interested in is an MT call with high priority (or high importance), as compared to the normal (or another) MT call will be described with reference to a connection establishment message to be described later.

In this connection, an example of the above paging message is as follows:

| Paging ::= | | SEQUENCE { |
|---|---|---|
| | pagingRecordList | PagingRecordList |

| | |
|---|---|
| OPTIONAL, | -- Need ON |

| | |
|---|---|
| systemInfoModification | ENUMERATED {true} |

| | |
|---|---|
| OPTIONAL, | -- Need ON |

| | | |
|---|---|---|
| etws-Indication | ENUMERATED | {true} |

| | |
|---|---|
| OPTIONAL, | -- Need ON |

| | |
|---|---|
| nonCriticalExtension | Paging-v890-IEs |

OPTIONAL

}

| Paging-v890-IEs ::= | | SEQUENCE { |
|---|---|---|
| | lateNonCriticalExtension | OCTET STRING |

OPTIONAL,

| | |
|---|---|
| nonCriticalExtension | Paging-v920-IEs |

OPTIONAL

}

| | |
|---|---|
| Paging-v920-IEs ::= | SEQUENCE { |

| | |
|---|---|
| cmas-Indication-r9 | ENUMERATED {true} |

| | |
|---|---|
| OPTIONAL, | -- Need ON |

| | |
|---|---|
| nonCriticalExtension | Paging-v1130-IEs |

OPTIONAL

}

| Paging-v1130-IEs | | SEQUENCE { |
|---|---|---|
| | eab-ParamModification-r11 | ENUMERATED {true} |

| | |
|---|---|
| OPTIONAL, | -- Need ON |

| | |
|---|---|
| nonCriticalExtension | SEQUENCE { } |

OPTIONAL

}

| | |
|---|---|
| PagingRecordList ::= | SEQUENCE (SIZE (1..maxPageRec)) |

OF PagingRecord

| | |
|---|---|
| PagingRecord ::= | SEQUENCE { |

| ue-Identity | |
|---|---|
| PagingUE-Identity, | |
| cn-Domain | |
| ENUMERATED {ps, cs}, | |
| highPriority-MTCall | ENUMERATED |

{true}, OPTIONAL

...

}

| | |
|---|---|
| PagingUE-Identity ::= | CHOICE { |

| | |
|---|---|
| s-TMSI | S-TMSI, |
| imsi | IMSI, |

...

}

| | |
|---|---|
| IMSI ::= | SEQUENCE (SIZE (6..21)) |

OF IMSI-Digit

| | |
|---|---|
| IMSI-Digit | INTEGER (0..9) |

-- ASN1STOP

The paging message may specifically indicate via the different parameters in each paging recode whether the MT call to be performed by the user device has a high priority.

The user device may receive paging messages from the network. The paging recode of the paging message received from the network by the user device may include information(s) about the types of MT call that the user device as the paging target should perform. The information(s) may include, for example, ‘signaling MT’, ‘emergency MT’, ‘high priority MT’, ‘delay-tolerant MT’ and/or ‘data MT’.

More specifically,

1) signaling MT (MT-signaling)
An indicator of ‘signaling MT’ (or information indicating ‘signaling MT’) instructs the network to treat or consider the MT call as an MT call having a high priority (or high importance) such that the network intends to prioritize the MT call during connection establishment.
If an indicator of ‘signaling MT’ is included in the paging recode of interest, the user device may consider the call of the user device as a signaling MT call.

In summary, the paging message received by the user device may include an indicator referred to as ‘signaling MT’. If the received paging message by the user device contains an indicator called ‘signaling MT’, the user device will perform an MT call. In order for the user device to perform the MT call, the user device transmits a connection establishment request message to the network. In this connection, the user device may include information indicating in the connection establishment request message that the MT call to be performed by the user device (in other words, the cause by which the user device transmits the connection request message) results from the ‘signaling MT’ received from the network. The network may know that the MT call performed by the user device needs to be prioritized, based on ‘the information indicating that the MT call to be performed by the user device results from the ‘signaling MT’ received from the network’ as included in the connection request message received from the user device.

2) emergency MT (MT-emergency)
An indicator of ‘emergency MT’ (or information indicating ‘emergency MT’) instructs the network to treat or consider the MT call as an MT call having a high priority (or high importance) such that the network intends to prioritize the MT call during connection establishment.
If an indicator of ‘emergency MT’ is included in the paging recode of interest, the user device may consider the call of the user device as an emergency MT call.

In summary, the paging message received by the user device may include an indicator referred to as ‘emergency MT’. If the received paging message by the user device contains an indicator called ‘emergency MT’, the user device will perform an MT call. In order for the user device to perform the MT call, the user device transmits a connection establishment request message to the network. In this connection, the user device may include information indicating in the connection establishment request message that the MT call to be performed by the user device (in other words, the cause by which the user device transmits the connection request message) results from the ‘emergency MT’ received from the network. The network may know that the MT call performed by the user device needs to be prioritized, based on ‘the information indicating that the MT call to be performed by the user device results from the ‘emergency MT’ received from the network’ as included in the connection request message received from the user device.

3) high priority MT (MT-high priority)
An indicator of ‘high priority MT’ (or information indicating ‘high priority MT’) instructs the network to treat or consider the MT call as an MT call having a high priority (or high importance) such that the network intends to prioritize the MT call during connection establishment.
If an indicator of ‘high priority MT’ is included in the paging recode of interest, the user device may consider the call of the user device as a high priority MT call.

In summary, the paging message received by the user device may include an indicator referred to as ‘high priority MT’. If the received paging message by the user device contains an indicator called ‘high priority MT’, the user device will perform an MT call. In order for the user device to perform the MT call, the user device transmits a connection establishment request message to the network. In this connection, the user device may include information indicating in the connection establishment request message that the MT call to be performed by the user device (in other words, the cause by which the user device transmits the connection request message) results from the ‘high priority MT’ received from the network. The network may know that the MT call performed by the user device needs to be prioritized, based on ‘the information indicating that the MT call to be performed by the user device results from the ‘high priority MT’ received from the network’ as included in the connection request message received from the user device.

4) Delay tolerant MT (MT-delay tolerant)
An indicator of ‘delay tolerant MT’ (or information indicating ‘delay tolerant MT’) instructs the network to treat or consider the MT call as an MT call having a low priority (or low importance) such that the network intends to non-prioritize the MT call during connection establishment.
If an indicator of ‘delay tolerant MT’ is included in the paging recode of interest, the user device may consider the call of the user device as a delay tolerant MT call.

In summary, the paging message received by the user device may include an indicator referred to as ‘delay tolerant MT’. If the received paging message by the user device contains an indicator called ‘delay tolerant MT’, the user device will perform an MT call. In order for the user device to perform the MT call, the user device transmits a connection establishment request message to the network. In this connection, the user device may include information indicating in the connection establishment request message that the MT call to be performed by the user device (in other words, the cause by which the user device transmits the connection request message) results from the ‘delay tolerant MT’ received from the network. The network may know that the MT call performed by the user device has a low priority, based on ‘the information indicating that the MT call to be performed by the user device results from the ‘delay tolerant MT’ received from the network’ as included in the connection request message received from the user device.

5) Data MT (MT-data)
An indicator of ‘data MT’ (or ‘information indicating data MT) may instruct the network not to perform any special handling of the MT call.
If the indicator of ‘data MT’ is included in the paging recode of interest, the user device may consider the call of the user device as a normal MT call.

3. The Priority Indicator within the Paging

The paging recode of the paging message may include information indicating the priority of the MT call. An example of a paging message received from this network by the user device may be as follows:

| Paging ::= | | SEQUENCE { |
|---|---|---|
| | pagingRecordList | PagingRecordList |

| | |
|---|---|
| OPTIONAL, | -- Need ON |

| | |
|---|---|
| systemInfoModification | ENUMERATED {true} |

| | |
|---|---|
| OPTIONAL, | -- Need ON |

| | | |
|---|---|---|
| etws-Indication | ENUMERATED | {true} |

| | |
|---|---|
| OPTIONAL, | -- Need ON |

| | |
|---|---|
| nonCriticalExtension | Paging-v890-IEs |

OPTIONAL

}

| Paging-v890-IEs ::= | | SEQUENCE { |
|---|---|---|
| | lateNonCriticalExtension | OCTET STRING |

OPTIONAL,

| | |
|---|---|
| nonCriticalExtension | Paging-v920-IEs |

OPTIONAL

}

| | |
|---|---|
| Paging-v920-IEs ::= | SEQUENCE { |

| | |
|---|---|
| cmas-Indication-r9 | ENUMERATED {true} |

| | |
|---|---|
| OPTIONAL, | -- Need ON |

| | |
|---|---|
| nonCriticalExtension | Paging-v1130-IEs |

OPTIONAL

}

| Paging-v1130-IEs ::= | | SEQUENCE { |
|---|---|---|
| | eab-ParamModification-r11 | ENUMERATED {true} |

| | |
|---|---|
| OPTIONAL, | -- Need ON |

| | |
|---|---|
| nonCriticalExtension | SEQUENCE { } |

OPTIONAL

}

| | |
|---|---|
| PagingRecordList ::= | SEQUENCE (SIZE (1..maxPageRec)) |

OF PagingRecord

| | |
|---|---|
| PagingRecord | SEQUENCE { |

| ue-Identity | |
|---|---|
| PagingUE-Identity, | |
| cn-Domain | |
| ENUMERATED {ps, cs}, | |
| priority | INTEGER (0...7) |

OPTIONAL

...

}

| | |
|---|---|
| PagingUE-Identity ::= | CHOICE { |

| | |
|---|---|
| s-TMSI | S-TMSI, |
| imsi | IMSI, |

...

}

| | |
|---|---|
| IMSI ::= | SEQUENCE (SIZE (6..21)) |

OF IMSI-Digit

| | |
|---|---|
| IMSI-Digit ::= | INTEGER (0..9) |

-- ASN1STOP

In step S1120, the user device may transmit an RRC connection request message including information indicating the importance of the call that caused the connection establishment, based on the received paging message.

More specifically,

1. With respect to the MT call, when the device receives an indication via the paging recode of the paging message to indicate whether or not the MT call to be performed by the user device has a high priority

If the MT call is paged by the network, the user device may configure the cause information (that is, information about RRC connection establishment cause) for the connection establishment request message to be transmitted by the user device as follows.
if the connection establishment request (or connection establishment request message) is triggered by a paging message containing information indicating high priority (or high importance), the user device may configure the cause information in the RRC connection establishment (or setup) request message as information (for example, MT-HighPriority) indicating that the connection establishment is a connection establishment resulting from an MT call having a high priority.
if the connection establishment request (or connection establishment request message) is triggered by a paging message not containing information indicating high priority (or high importance), the user device may configure the cause information in the RRC connection establishment (or setup) request message as information (for example, MT-Access) indicating that the connection establishment is a connection establishment resulting from an MT call having a normal priority.

In this connection, the details of an example of the cause information (that is, cause information about the connection establishment) may be as follows.

| | |
|---|---|
| EstablishmentCause ::= | ENUMERATED { |

emergency, highPriorityAccess, mt-Access, mo-Signalling,
mo-Data, delayTolerantAccess-v1020, MT-HighPriority, spare1}

In this connection, ‘highPriorityAccess’ may be information indicating that the connection establishment has occurred by an MO call of a special user device, while the ‘MT-High Priority’ may be information indicating that the connection setup request is triggered by an MT call having high priority (or high importance), as described above.

2. A case when a call type indicating whether the MT call to be performed by the user device has a high or low priority via each paging recode of the paging message is explicitly indicated to the user device

If the MT call is paged by the network, the user device may configure the cause information (that is, information about the RRC connection establishment cause) of the connection establishment request message to be transmitted by the user device as follows.
if the connection setup request is triggered by a paging message including a signaling call type, the user device may configure the cause information in the RRC connection establishment (or setup) request message as a high priority MT (for example, ‘mt-Signaling’).
if the connection setup request is triggered by a paging message including an emergency call type, the user device may configure the cause information in the RRC connection establishment (or setup) request message as a high priority MT (for example, ‘mt-Emergency’).
if the connection setup request is triggered by a paging message including a high priority call type, the user device may configure the cause information in the RRC connection establishment (or setup) request message as a high priority MT (for example, ‘mt-HighPriority’). The high priority call type may be indicated as, for example, a high priority call. Meanwhile, in order to distinguish a voice or video call from another call, information indicating a voice call or a video call may be included in the paging message. In this case, the user device indicates the cause in the connection setup request message as a voice call or a video call. This allows the user device to expect voice or video calls to be treated as call having high priority by the network.
if the connection setup request is triggered by a delay-tolerant MT call, the user device may configure the cause information in the RRC connection establishment (or setup) request message as an MT (for example, ‘mt-delayTolerant’) having a low priority.
if the connection setup request is triggered by data MT, the user device may configure the cause information in the RRC connection establishment (or setup) request message as MT-Access (mt-Access).

In one example, the user device may configure the RRC connection establishment request message to indicate the specific type of MT call as follows:

A

| | |
|---|---|
| EstablishmentCause_MT ::= | ENUMERATED { |

mt-signaling, mt-emergency, mt-highPriority, mt-delayTolerant, mt-Data, spare3,
spare2, spare1}

3. When the priority index in the paging message is received by the user device

The user device may also transmit a connection establishment message to the network. In this connection, the cause by which the user device transmits the connection establishment message to the network is due to an MT call upon receiving a paging message including a priority index. In this connection, when the user device transmits the connection establishment (for example, RRC connection establishment) message, the user device may include the priority of the call that caused the connection establishment message transmission into the connection establishment message. If the connection establishment is triggered by a paging message including information on priority (that is, if the user device decides to perform an MT call via the paging message including information on priority, and then the device performs connection establishment to perform the MT call), the user device may indicate a priority via a connection establishment request message. In summary, the user device receives a paging message from the base station containing information about the priority (or importance) of the call, and, the user device determines to perform the MT call based on the paging message. Thus, the device transmits the connection establishment request message to the base station, the user device may include information about the priority (or importance) of the MT call into the connection establishment request message.

Meanwhile, when the user device receives a paging message including priority information of an MT call, the network may configure the timings of transmitting the paging message differently based on the priorities of the MT call. That is, the timing at which the user device monitors the paging message, so-called paging occasions (PO), may be configured differently based on the priorities of the message. It is possible for a plurality of priorities to share the same PO. For example, a paging period with four POs is configured for the user device. Each PO of the four POs is associated with a specific priority. A plurality of POs included in one paging period are allocated resources that are distinguished in time or on frequency. When as described above, the transmission timings of the paging message are configured differently based on the priorities of the MT call, the user device may advantageously determine the priority of the paging message based on the timings of receiving the paging message. This eliminates the overhead incurred by including separate information on the priority of the call in the paging message.

In this connection, the RRC connection request message for RRC connection establishment may be as follows. In this connection, the signaling radio bearer of the RRC connection request message may be SRB0, RLC-SAP thereof may be TM, a local channel thereof may be a CCCH. In addition, the RRC connection request message is transmitted from the user device to the network.

In one example,

-- ASN1START

| | |
|---|---|
| RRCConnectionRequest ::= | SEQUENCE { |

| | |
|---|---|
| criticalExtensions | CHOICE { |

rrcConnectionRequest-r8

RRCConnectionRequest-r8-IEs,

| | |
|---|---|
| criticalExtensionsFuture | SEQUENCE { } |

}

}

| | |
|---|---|
| RRCConnectionRequest-r#-IEs ::= | SEQUENCE { |

| ue-Identity | |
|---|---|
| InitialUE-Identity, | |
| priority | INTEGER (0...7) |

}

| | |
|---|---|
| InitialUE-Identity ::= | CHOICE { |

| | |
|---|---|
| s-TMSI | S-TMSI, |
| randomValue | BIT |

STRING (SIZE (40))
}
-- ASN1STOP

According to this example, the user device may include information about the priority of a call into the RRC connection request message. The ‘priority’ field may be configured to have a value from 0 to 7. The network may determine the priority of the call that caused the RRC connection request message based on the field. In this connection, the network may determine the priorities among the RRC connection request messages received by the network via the configured values in the field.

In another example,

| -- ASN1START | |
|---|---|
| RRCConnectionRequest ::= | SEQUENCE { |

| | |
|---|---|
| criticalExtensions | CHOICE { |

rrcConnectionRequest-r8

RRCConnectionRequest-r8-IEs,

| | |
|---|---|
| criticalExtensionsFuture | SEQUENCE { } |

}

| } | |
|---|---|
| RRCConnectionRequest-r#-IEs ::= | SEQUENCE { |

ue-Idenity
InitialUE-Identity,
highPriority
ENUMERATED {true}

| } | |
|---|---|
| InitialUE-Identity ::= | CHOICE { |

| | |
|---|---|
| s-TMSI | S-TMSI, |
| randomValue | BIT |

| STRING (SIZE (40)) | |
|---|---|
| } | |
| EstablishmentCause ::= | ENUMERATED { |

emergency, highPriorityAccess, mt-Access, mo-Signalling,
mo-Data, delayTolerantAccess-v1020, spare2, spare1}

-- ASN1STOP

According to this example, the user device may include information indicating whether a call has a high priority into an RRC connection request message. The information may have a single bit. For example, if the value of the highPriority field is ‘1’, the network determines that the priority of the connection request message is high, while if the value of the field is ‘0’, the network may determine that the priority of the connection request message is low. Alternatively, if the value of the highPriority field is ‘0’, the network determines that the priority of the connection request message is high, while, if the value of the field is ‘1’, the network may determine that the priority of the connection request message is low.

In still another example,

-- ASN1START

| | |
|---|---|
| RRCConnectionRequest ::= | SEQUENCE { |

| | |
|---|---|
| criticalExtensions | CHOICE { |

rrcConnectionRequest-r8

RRCConnectionRequest-r8-IEs,

| | |
|---|---|
| criticalExtensionsFuture | SEQUENCE { } |

}

}

| | |
|---|---|
| RRCConnectionRequest-r#-IEs ::= | SEQUENCE { |

| ue-Identity | |
|---|---|
| InitialUE-Idenitity, | |
| establishmentCause | EstablishmentCause, |

}

| | |
|---|---|
| InitialUE-Identity ::= | CHOICE { |

| | |
|---|---|
| s-TMSI | S-TMSI, |
| randomValue | BIT |

STRING (SIZE (40))
}

| | |
|---|---|
| EstablishmentCause ::= | ENUMERATED { |

emergency, highPriorityAccess, mt-Access, mo-Signalling,
mo-Data, delayTolerantAccess-v1020, prioriitizedAccess, spare1}

-- ASN1STOP

In this example, ‘EstablishmentCause’, that is, the field for connection establishment cause may contain information indicating that the call has a high priority.

The case of MO call is explained.

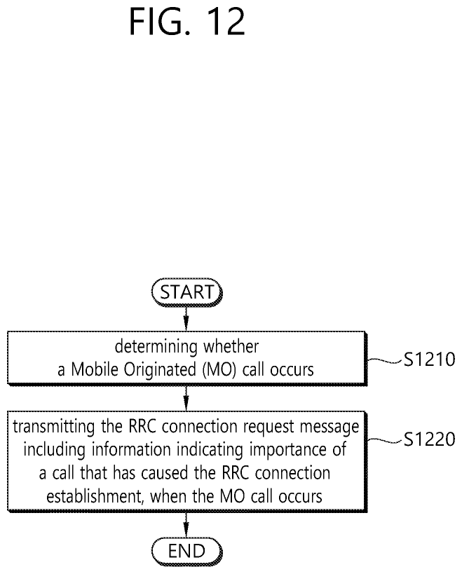

FIG. 12 is the flowchart of the method of transmitting information indicating the importance of the call via the RRC connection request message when an MO call occurs, in accordance with one embodiment.

Referring to FIG. 12, the user device may determine whether an MO call has occurred (S1210). The details of determining, by the user device, whether the MO call has occurred are as described above.

Thereafter, when an MO call occurs, the user device may transmit an RRC connection request message including information indicating the importance of the call that caused the establishment of the connection (S1220).

More specifically,

when the user device transmits a connection establishment message for an MO call, the user device may include into the connection establishment message the priority of the call that caused the connection establishment message transmission or information related to the priority of the call. In this connection, the information (for example, the priority (or importance) to be transmitted by the user device or information related to the priority (or importance)) may be as follows.

1) Priority of data triggering connection establishment: The priority may be configured by the upper layer (for example, the priority may be per packet priority configured by the upper layer).

2) If the call is an MO call triggered by an application which is subjected to an access control based on the service category, service category: in this connection, each service category is associated with priority (or importance).

3) Call priority based on the priority configuration rule provided to the user device

4) prioritized access indicator
The user device may configure the value of the indicator for user devices not related to access classes 11-15.
if the call is a VoLTE call, the user device may indicate that the call is a VoLTE call.
If the priority of the call (priority related to data priority—for example, per-packet priority, or service/application category) exceeds the threshold, the user device may indicate that the priority of the call exceeds the threshold or indicate that the call is a call with a high priority.

In this connection, the RRC connection request message for RRC connection establishment may be as follows. In this connection, the signaling radio bearer of the RRC connection request message may be SRB0, RLC-SAP thereof may be TM, and local channel thereof may be CCCH. In addition, the RRC connection request message is transmitted from the user device to the network.

In one example,

-- ASN1START

| | |
|---|---|
| RRCConnectionRequest ::= | SEQUENCE { |

| | |
|---|---|
| criticalExtensions | CHOICE { |

rrcConnectionRequest-r8

RRCConnectionRequest-r8-IEs,

| | |
|---|---|
| criticalExtensionsFuture | SEQUENCE { } |

}

}

| | |
|---|---|
| RRCConnectionRequest-r#-IEs ::= | SEQUENCE { |

| ue-Identity | |
|---|---|
| InitialUE-Identity, | |
| priority | INTEGER (0...7) |

}

| | |
|---|---|
| InitialUE-identity ::= | CHOICE { |

| | |
|---|---|
| s-TMSI | S-TMSI, |
| randomValue | BIT |

STRING (SIZE (40))
}
-- ASN1STOP

According to this example, the user device may include information about the priority of a call into the RRC connection request message. The ‘priority’ field may be configured to have a value from 0 to 7. The network may determine the priority of the call that caused the RRC connection request message based on the field. In this connection, the network may determine the priorities among the RRC connection request messages received by the network via the configured values in the field.

In another example,

| -- ASN1START | |
|---|---|
| RRCConnectionRequest ::= | SEQUENCE { |

| | |
|---|---|
| criticalExtensions | CHOICE { |

rrcConnectionRequest-r8

RRCConnectionRequest-r8-IEs,

| | |
|---|---|
| criticalExtensionsFuture | SEQUENCE { } |

}

| | |
|---|---|
| } | |
| RRCConnectionRequest-r#-IEs ::= | SEQUENCE { |

ue-Identity
InitialUE-Identity,
highPriority
ENUMERATED {true}

| } | |
|---|---|
| InitialUE-Identity ::= | CHOICE { |

| | |
|---|---|
| s-TMSI | S-TMSI, |
| randomValue | BIT |

| STRING (SIZE (40)) | |
|---|---|
| } | |
| EstablishmentCause ::= | ENUMERATED { |

emergency, highPriorityAccess, mt-Access, mo-Signalling,
mo-Data, delayTolerantAccess-v1020, spare2, spare1}

-- ASN1STOP

According to this example, the user device may include information indicating whether a call has a high priority into an RRC connection request message. The information may have a single bit. For example, if the value of the highPriority field is ‘1’, the network determines that the priority of the connection request message is high, while if the value of the field is ‘0’, the network may determine that the priority of the connection request message is low. Alternatively, if the value of the highPriority field is ‘0’, the network determines that the priority of the connection request message is high, while, if the value of the field is ‘1’, the network may determine that the priority of the connection request message is low.

In still another example,

-- ASN1START

| | |
|---|---|
| RRCConnectionRequest ::= | SEQUENCE { |

| | |
|---|---|
| criticalExtensions | CHOICE { |

rrcConnectionRequest-r8

RRCConnectionRequest-r8-IEs,

| | |
|---|---|
| criticalExtensionsFuture | SEQUENCE { } |

}

}

| | |
|---|---|
| RRCConnectionRequest-r#-IEs ::= | SEQUENCE { |

| ue-Identity | |
|---|---|
| InitialUE-Identity, | |
| establishmentCause | EstablishmentCause, |

}

| | |
|---|---|
| InitialUE-Identity ::= | CHOICE { |

| | |
|---|---|
| s-TMSI | S-TMSI, |
| randomValue | BIT |

STRING (SIZE (40))
}

| | |
|---|---|
| EstablishmentCause ::= | ENUMERATED { |

emergency, highPriorityAccess, mt-Access, mo-Signalling,
mo-Data, delayTolerantAccess-v1020, prioriitizedAccess, spare1}

-- ASN1STOP

In this example, ‘EstablishmentCause’, that is, the field for connection establishment cause may contain information indicating that the call has a high priority.

II. When the Information Indicating the Importance of the Call is Transmitted after the RRC Connection Completion

In the above embodiments, it has been assumed that the user device transmits the priority information of the call via the RRC connection establishment request message, as suggested by the present invention. Alternatively, it is possible that the user device transmits the priority of the call after the completion of the connection establishment of the call. For example, the user device may include the information into an RRC connection establishment completion message indicating that the RRC connection establishment has been completed and may transmit the message. Meanwhile, the network may indicate to the user device via the system information whether the user device sends the priority information of the call before the RRC connection or after the RRC connection. Based on the system information, the user device determines whether the priority information of the call is sent before the RRC connection or after the RRC connection. For example, based on the system information, the device may determine whether to include the priority information of the call into an RRC connection establishment request message or into the RRC connection establishment completion message.

This example will be described below with reference to the drawings.

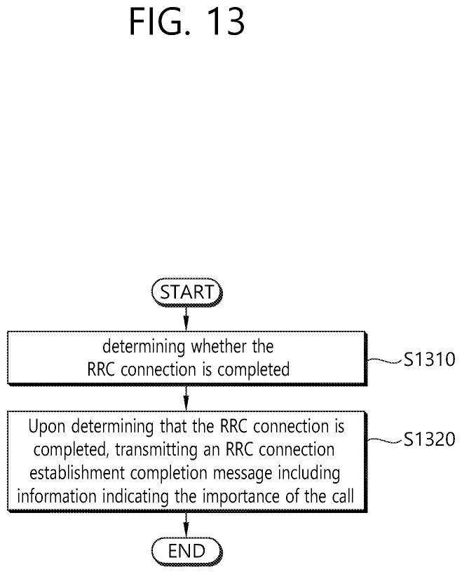

FIG. 13 is a sequence of a method for transmitting information indicating the importance of a call via an RRC connection completion message according to one embodiment of the present invention.

Referring to FIG. 13, the user device determines whether the RRC connection is completed (S1310). That is, the user device may receive from the network the information indicating whether the user device sends priority information of the call before the RRC connection or after the RRC connection. If the information indicates that the user device should send the priority information of the call after the RRC connection, the user device may determine whether the RRC connection has been completed. Alternatively, if it is determined that the priority information of the call is to be transmitted prior to the RRC connection, the examples of the embodiments described above may be applied.

After the RRC connection is completed, the device may transmit an RRC connection establishment completion message including information indicating the importance of the call (S1320). In this connection, a specific example of the information (that is, information indicating the importance of the call) transmitted by the user device to the network is as described above (for example, see the example of FIGS. 9 to 12)

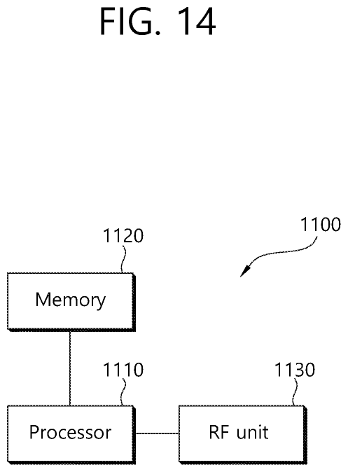

FIG. 14 is a block diagram illustrating the user device in which an embodiment of the present invention is implemented.

Referring to FIG. 14, the user device 1100 includes a processor 1110, a memory 1120, and a radio frequency unit 1130. For example, the processor 1110 determines whether to perform RRC connection establishment (for example, the processor may determine whether to receive a paging message or not to trigger a mobile originated (MO) call). If the RRC connection establishment is determined to be performed, the processor 1110 may transmit an RRC connection establishment message including information indicating importance.

The RF unit 1130 is connected to the processor 1110 to transmit and receive radio signals.

The processor may comprise an application-specific integrated circuit (ASIC), other chipset, logic circuitry and/or a data processing device. The memory may include read-only memory (ROM), random access memory (RAM), flash memory, memory card, storage media and/or other storage devices. The RF unit may include a baseband circuit for processing the radio signal. When the embodiment is implemented in software, the above-described techniques may be implemented with modules (processes, functions, etc.) that perform the functions described above. The module may be stored in memory and executed by the processor. The memory may be internal or external to the processor, and may be coupled to the processor by any of a variety of well known means.

What is claimed is:

1. A method for transmitting a Radio Resource Control (RRC) message by a user equipment (UE) in a wireless communication system, the method comprising:
determining whether to transmit a RRC message; and
transmitting the RRC message upon determination to transmit the RRC message,
wherein the RRC message includes information indicating importance of a call that has caused the RRC message transmission.

2. The method of claim 1, wherein determining whether to transmit the RRC message comprises determining whether to perform RRC connection establishment,
wherein the RRC message is an RRC connection request message,
wherein the information indicating the importance of the call is information indicating importance of a call that has caused the RRC connection establishment.

3. The method of claim 2, wherein determining whether to perform the RRC connection establishment comprises receiving a paging message,
wherein transmitting the RRC connection request message includes transmitting the RRC connection request message based on the received paging message.

4. The method of claim 3, wherein the paging message includes the information indicating the importance of the call.

5. The method of claim 4, wherein the information indicating the importance of the call that has caused the RRC connection establishment is determined based on the information indicating the importance of the call included in the paging message.

6. The method of claim 4, wherein the information indicating the importance of the call is included in a paging recode of the paging message.

7. The method of claim 4, wherein when the information indicating the importance of the call is not included in the paging message, the call has normal importance or normal priority.

8. The method of claim 4, wherein the information indicating the importance of the call includes information indicating that the call has high importance or high priority.

9. The method of claim 1, wherein determining whether to perform the RRC connection establishment comprises determining whether a Mobile Originated (MO) call occurs,
wherein transmitting the RRC connection request message includes transmitting the RRC connection request message when the MO call occurs.

10. The method of claim 1, wherein the information indicating the importance of the call that has caused the RRC connection establishment includes information indicating a priority of the call that has caused the RRC connection establishment.

11. The method of claim 1, wherein the information indicating the importance of the call that has caused the RRC connection establishment includes information about a service category.

12. The method of claim 1, wherein the call is a VoLTE (Voice over LTE) call.

13. The method of claim 1, wherein the RRC message is an RRC connection completion message.

14. The method of claim 1, further comprising receiving information indicating whether to send the RRC message before the RRC connection or after the RRC connection.

15. A user equipment (UE) comprising:
a radio frequency (RF) unit configured for transmitting and receiving a radio signal; and
a processor operatively coupled to the RF unit, wherein the processor is configured for:
determining whether to transmit a RRC message; and
controlling the RF unit to transmit the RRC message upon determination to transmit the RRC message,
wherein the RRC message includes information indicating importance of a call that has caused the RRC message transmission.
